(19) United States
(12) Patent Application Publication
(10) Pub. No.: US 2008/0197913 A1
(43) Pub. Date: Aug. 21, 2008

(54) ENERGY EFFICIENT VOLTAGE DETECTION CIRCUIT AND METHOD THEREFOR

(76) Inventor: Robert L. Chao, Los Altos, CA (US)

Correspondence Address: WEISS & MOY PC, 4204 NORTH BROWN AVENUE, SCOTTSDALE, AZ, 85251, US

(21) Appl. No.: 11/676,121

(22) Filed: Feb. 16, 2007

(51) Int. Cl. G05F 1/10

(52) U.S. Cl. 327/541

(57) ABSTRACT

A voltage detection circuit has a first MOSFET device having a drain, a gate, and a source terminal. A feedback element is coupled to the drain terminal and the gate terminal of the first MOSFET device. An input voltage is coupled to the gate terminal of the first MOSFET device. The voltage detection circuit is actively detecting a voltage from when the input voltage is in an OFF-state voltage region of the first MOSFET device. This detection continues through when the input voltage is at a sub-threshold voltage region of the first MOSFET, to when the input voltage exceeds the threshold voltage of the first MOSFET. This voltage detection circuit dissipates only a pre-selected drain-current at a level exceeding the drain-leakage current of the first MOSFET, as power dissipation.

### FIELD OF THE INVENTION

The present invention relates generally to a voltage detection circuit, and more specifically, to an energy efficient voltage-detector circuit that consumes a miniscule amount of current and hence operates at a very low level of power dissipation.

### BACKGROUND OF THE INVENTION

Voltage comparators are used widely in the electronic industry in many applications. One well-known application function of a voltage comparator is that of a voltage detector. A voltage detector circuit, as shown in FIG. 1, consists of a voltage comparator circuit and a voltage reference circuit, with an input terminal and an output terminal. The voltage reference circuit provides a reference voltage to the voltage comparator. The voltage detector circuit functions by comparing an input voltage at the input terminal to that of a voltage supplied by the reference voltage inputted to the voltage comparator. The output of the voltage comparator circuit will provide an indication at its output voltage on whether an unknown input voltage is below or above this reference voltage.

In many applications, it is necessary that such voltage detectors are made small and compact for space and cost considerations. In yet other applications, it is critical that such voltage detectors operate with a minimum of power dissipation. For applications in fields such as the energy-harvesting applications, where a waste energy source is captured and gathered, detected, accumulated, converted, stored and managed by an electronic-management circuit for useful purposes such as driving conventional electronic circuits at a later time, an energy-efficient voltage-detector circuit is required. In order for such a voltage-detector circuit to operate successfully, its own power dissipation, and hence its energy efficiency is one of the critical factors. The power dissipation used by this voltage-detector circuit as an electronic energy-management circuit must be subtracted from the waste energy captured and converted, and only any surplus waste energy that this circuit has not consumed can be converted into useful stored electrical energy. At the heart of such an electronic-management circuit is the critical need of an energy efficient voltage-detector circuit.

Therefore, it would be desirable to provide a circuit and method to overcome the above problem.

### SUMMARY OF THE INVENTION

In accordance with one embodiment of the present invention, a voltage detection circuit is disclosed. The voltage detection circuit has a first MOSFET device having a drain, a gate, and a source terminal. A feedback element is coupled to the drain terminal and the gate terminal of the first MOSFET device. An input voltage is coupled to the gate terminal of the first MOSFET device. The voltage detection circuit is actively detecting a voltage from when the input voltage is in an OFF-state voltage region of the first MOSFET device. This detection continues through when the input voltage is at a sub-threshold voltage region of the first MOSFET, to when the input voltage exceeds the threshold voltage of the first MOSFET. The voltage detection circuit dissipates only a pre-selected drain-current at a level exceeding the drain-leakage current of the first MOSFET as power dissipation.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a simplified functional block diagram of a voltage detector, consisting of a voltage comparator and a voltage reference.

FIG. 2 is a simplified functional block diagram of the voltage detector circuit of the present invention.

FIG. 3 is a simplified functional block diagram of another embodiment of the voltage detector circuit of the present invention.

FIG. 4 is a simplified functional block diagram of another embodiment of the voltage detector circuit of the present invention.

FIG. 5 is a simplified functional block diagram of another embodiment of the voltage detector circuit of the present invention.

FIG. 6 is a simplified functional block diagram of another embodiment of the voltage detector circuit of the present invention.

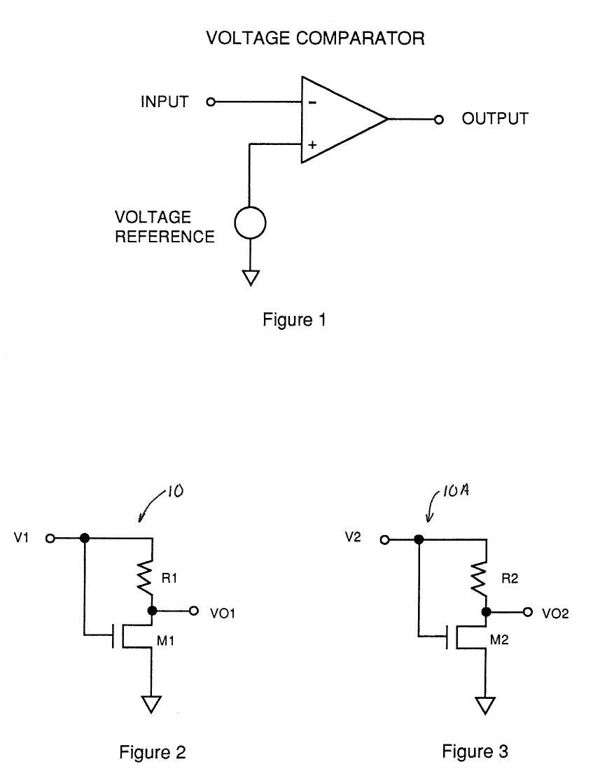

### DESCRIPTION OF PREFFERED EMBODIMENT

Referring to FIG. 2, a MOSFET device M1 is connected as a voltage detector circuit 10. V1 is the input to the voltage detector circuit 10, and VO1 is the output of the voltage detector circuit 10. The voltage detector circuit 10 has one feedback element R1 connected between V1 and Vo1, or between the gate terminal and the drain terminal of the MOSFET device M1. While a resistor is shown as the feedback element R1, this should not be seen as to limit the scope of the present invention. Other devices such as a passive device, an active device, a bipolar device, a MOSFET device and the like may be used as the feedback element R1 without departing from the spirit and scope of the present invention. The MOSFET device M1 and the feedback element R1 in combination operate as a voltage detector circuit 10. The voltage comparator circuit and the reference circuit are embedded in the basic threshold characteristics of the MOSFET device M1.

The useful operating voltage range of the MOSFET device M1 for the voltage detector circuit 10 is from a voltage close to its threshold voltage, Vth1, at a value slightly above, equal to or below its threshold voltage in an operating region known as its sub-threshold voltage region. The threshold voltage Vth1 of the MOSFET device M1 is generally regarded as a voltage at which the MOSFET device M1 is turned-on or turned off, as specified at a drain current. The sub-threshold voltage of the MOSFET device is any voltage below threshold voltage where the gate voltage exercises control of the drain current of the MOSFET device M1. In other words, the sub-threshold voltage region of the MOSFET device M1 is a voltage region below its threshold voltage Vth1 where the drain-current of the MOSFET device M1 decreases exponentially with a small, linear decrease in its gate voltage. In this region of operation, the drain-current of the MOSFET M1 typically decreases by many orders of magnitude with a few tenths of a volt decrease in gate voltage. At gate voltages below sub-threshold voltage, at a point where the drain-current is comparable in magnitude to its drain-leakage current, the MOSFET device M1 is now in the OFF-state. At gate voltages lower than this OFF-state voltage, the drain current of the MOSFET device M1 is primarily the drain leakage current of the MOSFET drain junction, and the gate voltage of the MOSFET device M1 ceases to exercise control over the drain current in the conducting channel.

In FIG. 2, V1 is the input to the voltage-detector circuit 10, the MOSFET device M1 acts as a voltage comparator and compares V1 to its own threshold voltage Vth1. Vth1 is acting as the reference voltage. When V1 is in the OFF-state voltage region of the MOSFET device M1, the voltage detection circuit is actively detecting a voltage, and yet the voltage detector 10 dissipates only MOSFET drain-leakage current as its power dissipation. When V1 voltage rises to within the sub-threshold voltage region of the MOSFET device M1, a suitable feedback element of value R1 at a pre-selected drain-current of the MOSFET device M1 in its sub-threshold voltage region causes a change to VO1 to signal a voltage detection. Hence the circuit functions as a voltage detector circuit 10, with its reference voltage at that pre-selected sub-threshold voltage and at a pre-selected drain-current level.

The voltage-detector circuit 10 also functions at a gate voltage at or above the threshold voltage Vth1 of the MOSFET device M1, albeit at a higher drain-current, resulting in a higher power dissipation level. Upon reaching a certain drain-current level at or above the threshold voltage Vth1 of the MOSFET device M1, the voltage detector circuit 10 ceases to have power dissipation advantage as compared to other types of conventional voltage-detector circuits, although it still retains the small size, simplicity and cost advantages.

In FIG. 3, a second voltage-detector circuit 10A using the same circuit configuration as in FIG. 2 is shown. The voltage-detector circuit 10A has an input voltage V2 and output voltage VO2. By using a MOSFET device M2 with a threshold voltage Vth2 different from the threshold voltage Vth1 of the MOSFET device M1 used in the first voltage-detector circuit 10 described in FIG. 2 and a different feedback element R2, a voltage-detector circuit 10A with a different reference voltage can be implemented. Similarly a third voltage-detector circuit (not shown) with a third set of input and output voltages, with its respective MOSFET threshold Vth3 feedback element R3 can be built. A plurality of voltage-detector circuits with a plurality of respective threshold voltages produces a plurality of voltage-detector circuits, each with a distinct and different corresponding reference voltage.

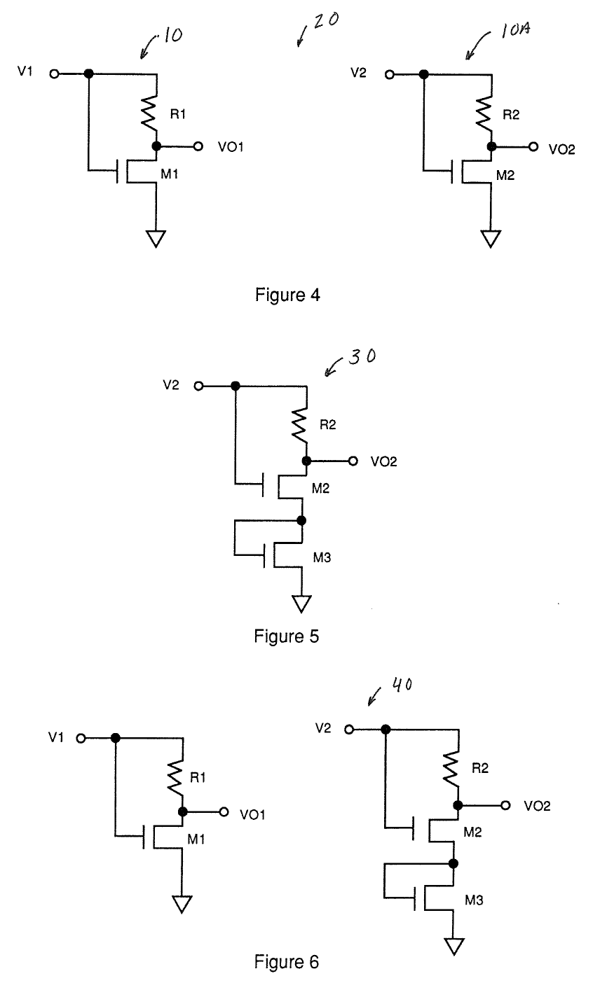

In FIG. 4, the voltage-detector circuits 10 and 10A with inputs V1 and V2 and their respective outputs VO1 and VO2 detects voltages based on the respective MOSFET devices M1 and M2, each with its respective threshold voltages Vth1 and Vth2. In combining the pair of voltage detector circuits 10 and 10A, a dual reference limit voltage-detector circuit 20 can be built where there are two outputs, VO1 and VO2 which correspond to a high-limit and a low-limit voltage indication.

In FIG. 5, a variation of the above described voltage-detector circuit 10A in FIG. 3 is shown. In this embodiment, the voltage detector circuit 30 has an additional MOSFET device M3, with either the same or a different threshold voltage to the MOSFET device M2, added to the circuit 30. The source of the MOSFET device M2, instead of being connected to a reference ground potential, as shown in FIG. 3, is connected to the drain and gate terminal of the MOSFET device M3. The source terminal of the MOSFET device M3 is then connected to the reference ground potential. In this circuit configuration, the voltage-detector circuit 30 detects at a reference voltage equal to the sum of the threshold or sub-threshold voltages of the MOSFET devices M2 and M3, as specified by their respective drain currents.

The circuit configuration described in the above paragraph is referred to as MOSFET stacking, with MOSFET device M2 stacked on top of MOSFET device M3. A plurality of MOSFET devices, each with the same or a different threshold voltage from M2 and M3, can be stacked on top of each other. In MOSFET stacking, each successive MOSFET device with its respective drain and gate terminals connected together has its source terminal connected to the drain and gate terminals of a previous MOSFET device. The last MOSFET device in the MOSFET stack will have its source terminal connected to the reference ground potential. The reference voltage of a voltage detector circuit with a number of MOSFET devices stacked on top of each other in this circuit configuration is equal to the sum of their corresponding threshold or sub-threshold voltages at a specified drain current.

FIG. 6 shows a variation of a dual limit voltage-detector circuit shown in FIG. 4 using a combination of voltage detector circuits described in FIG. 2 and FIG. 5. The circuit 40 in FIG. 6 demonstrates a variation of combination in the use of voltage-detector circuits shown in FIG. 2, FIG. 3 and FIG. 5. A plurality of these combinations can be implemented using discrete MOSFET devices or in integrated circuit implementation, using either N-channel MOSFET devices or P-channel MOSFET devices, as this circuit invention is compatible and can be implemented with all these types of MOSFET devices.

Similarly, a combination of these voltage-detector circuits can be used in a larger collection of voltage-detector circuits, each with a different reference voltage corresponding to a combination of their respective threshold or sub-threshold voltages.

In summary, an energy efficient voltage-detector circuit based on a MOSFET device, with the threshold of the MOSFET itself used as a voltage reference, is biased to operate at or below its threshold voltage. Under such conditions, the voltage-detector circuit consumes a miniscule amount of current and hence operates at a very low level of power dissipation.

A plurality of such voltage detector circuits can be connected together to provide multiple voltage detector circuits, each detecting a different voltage level, and each voltage detector circuit is based on a different threshold voltage of its respective MOSFET device. A number of variations of this voltage-detector circuit and a combination of the variation of this voltage-detector circuit provide a wide range of voltage-reference voltage implementations to produce many voltage-detector outputs.

This voltage detector circuit works with any MOSFET devices, whether as discrete MOSFET devices or in integrated circuit form, and whether using N-channel or P-channel type MOSFET devices. The above descriptions describe the operation of an N-type MOSFET device whereas the operation of a P-type MOSFET device works in the same manner, but with operating voltages in the opposite polarity.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A voltage detection circuit comprising:
a first MOSFET device having a drain, a gate, and a source terminal;
a feedback element coupled to the drain terminal and the gate terminal of the first MOSFET device; and
an input voltage coupled to the gate terminal of the first MOSFET device;
wherein the first MOSFET device functions as a voltage comparator and compares the input voltage to a threshold voltage of the first MOSFET device, the voltage detection circuit signals a voltage detection when the input voltage rises to above the OFF-state voltage region of the first MOSFET device.

2. A voltage detection circuit in accordance with claim 1 wherein the voltage detection circuit is actively detecting a voltage from when the input voltage is in an OFF-state voltage region of the first MOSFET device, detection continues through when the input voltage is in a sub-threshold voltage operating region of the first MOSFET, to when the input voltage exceeds the threshold voltage of the first MOSFET.

3. A voltage detection circuit in accordance with claim 1 wherein the voltage detection circuit is actively detecting a voltage from when the input voltage is in an OFF-state voltage region of the first MOSFET device, the voltage detection circuit dissipates only at a pre-selected drain-current at a level exceeding the drain-leakage current of the first MOSFET, as power dissipation.

4. A voltage detection circuit in accordance with claim 1 further comprising:
a second MOSFET device having a drain, a gate, and a source terminal;
a second feedback element coupled to the drain terminal and the gate terminal of the second MOSFET device; and
a second input voltage coupled to the gate terminal of the second MOSFET device;
wherein the second MOSFET device functions as a voltage comparator and compares the second input voltage to a threshold voltage of the second MOSFET device, the first MOSFET device and the second MOSFET device forming a dual reference limit voltage-detector circuit.

5. A voltage detection circuit in accordance with claim 1 further comprising a second MOSFET device having a drain, a gate, and a source terminal, the drain terminal of the second MOSFET device coupled to the source terminal of the first MOSFET device, the gate terminal of the second MOSFET device coupled to the drain terminal of the second MOSFET device, and the source terminal of the second MOSFET device coupled to ground potential.

6. A voltage detection circuit in accordance with claim 5 wherein the voltage-detector circuit detects at a reference voltage equal to the sum of the threshold or sub-threshold voltages of the first MOSFET device and the second MOSFET device, as specified at their respective drain currents.

7. A voltage detection circuit comprising:
a first MOSFET device having a drain, a gate, and a source terminal;
a feedback element coupled to the drain terminal and the gate terminal of the first MOSFET device; and
an input voltage coupled to the gate terminal of the first MOSFET device;
wherein the first MOSFET device functions as a voltage comparator and compares the input voltage to a threshold voltage of the first MOSFET device, the voltage detection circuit signals a voltage detection when the input voltage rises to above the OFF-state voltage region of the first MOSFET device;
wherein the voltage detection circuit is actively detecting a voltage from when the input voltage is in an OFF-state voltage region of the first MOSFET device and continues through when the input voltage is at a sub-threshold voltage region of the first MOSFET, to when the input voltage exceeds the threshold voltage of the first MOSFET, as the voltage detection circuit dissipating only a pre-selected drain-current at a level exceeding the drain-leakage current of the first MOSFET, as power dissipation.

8. A voltage detection circuit in accordance with claim 7 further comprising:
a second MOSFET device having a drain, a gate, and a source terminal;
a second feedback element coupled to the drain terminal and the gate terminal of the second MOSFET device; and
a second input voltage coupled to the gate terminal of the second MOSFET device;
wherein the second MOSFET device functions as a voltage comparator and compares the second input voltage to a threshold voltage of the second MOSFET device, the first MOSFET device and the second MOSFET device forming a dual reference limit voltage-detector circuit.

9. A voltage detection circuit in accordance with claim 7 further comprising a second MOSFET device having a drain, a gate, and a source terminal, the drain terminal of the second MOSFET device coupled to the source terminal of the first MOSFET device, the gate terminal of the second MOSFET device coupled to the drain terminal of the second MOSFET device, and the source terminal of the second MOSFET device at ground potential.

10. A voltage detection circuit in accordance with claim 9 wherein the voltage-detector circuit detects at a reference voltage equal to the sum of the threshold or sub-threshold voltages of the first MOSFET device and the second MOSFET device, as specified at their respective drain currents.

11. A voltage detection circuit comprising:
a first MOSFET device having a drain, a gate, and a source terminal;
a feedback element coupled to the drain terminal and the gate terminal of the first MOSFET device; and
an input voltage coupled to the gate terminal of the first MOSFET device;
wherein the voltage detection circuit is actively detecting a voltage from when the input voltage is in an OFF-state voltage region of the first MOSFET device and continues through when the input voltage is at a sub-threshold voltage region of the first MOSFET, to when the input voltage exceeds the threshold voltage of the first MOSFET, as the voltage detection circuit dissipates only a pre-selected drain-current at a level exceeding the drain-leakage current of the first MOSFET, as power dissipation.

12. A voltage detection circuit in accordance with claim 11 wherein the first MOSFET device functions as a voltage comparator and compares the input voltage to a threshold voltage of the first MOSFET device, the voltage detection circuit signals a voltage detection when the input voltage rises to above the OFF-state voltage region of the first MOSFET device;

13. A voltage detection circuit in accordance with claim 12 further comprising:
a second MOSFET device having a drain, a gate, and a source terminal;
a second feedback element coupled to the drain terminal and the gate terminal of the second MOSFET device; and
a second input voltage coupled to the gate terminal of the second MOSFET device;
wherein the second MOSFET device functions as a voltage comparator and compares the second input voltage to a threshold voltage of the second MOSFET device, the first MOSFET device and the second MOSFET device forming a dual reference limit voltage-detector circuit.

14. A voltage detection circuit in accordance with claim 12 further comprising a second MOSFET device having a drain, a gate, and a source terminal, the drain terminal of the second MOSFET device coupled to the source terminal of the first MOSFET device, the gate terminal of the second MOSFET device coupled to the drain terminal of the second MOSFET device, and the source terminal of the second MOSFET device coupled to reference ground potential.

15. A voltage detection circuit in accordance with claim 14 wherein the voltage-detector circuit detects at a reference voltage equal to the sum of the threshold or sub-threshold voltages of the first MOSFET device and the second MOSFET device, as specified at their respective drain currents.
